(19) United States
(12) Patent Application Publication
(10) Pub. No.: US 2013/0056642 A1
(43) Pub. Date: Mar. 7, 2013

(54) METHOD AND APPARATUS FOR MEASURING AERIAL IMAGE OF EUV MASK

(71) Applicants: Dong-gun LEE, Hwaseong-si (KR); Seong-sue Kim, Seoul (KR)

(72) Inventors: Dong-gun LEE, Hwaseong-si (KR); Seong-sue Kim, Seoul (KR)

(21) Appl. No.: 13/542,936

(22) Filed: Jul. 6, 2012

(30) Foreign Application Priority Data
Sep. 6, 2011 (KR) 10-2011-0090205

(51) Int. Cl. G01J 1/04

(52) U.S. Cl. 250/372

(57) ABSTRACT

An aerial image measuring apparatus includes an extreme ultra-violet (EUV) light generation unit configured to generate EUV light, a moving unit configured to mount an EUV mask and to move the EUV mask in x and y axis directions, a primary reduction optics configured to primarily reduce a divergence of the EUV light generated by the EUV light generation unit, a secondary reduction optics configured to secondarily reduce the divergence of the primarily reduced EUV light, and a detection unit configured to sense energy information from the secondarily reduced EUV light reflected from the plurality of regions on the EUV mask, the secondarily reduced EUV light being incident on and reflected from a plurality of regions on the EUV mask.

### CROSS-REFERENCE TO RELATED APPLICATIONS

This application claims the benefit of Korean Patent Application No. 10-2011-0090205, filed on Sep. 6, 2011, in the Korean Intellectual Property Office, the disclosure of which is incorporated herein in its entirety by reference.

### BACKGROUND

1. Field

The inventive concept relates to an aerial image measuring apparatus and method, and more particularly, to a method and apparatus for measuring an aerial image of an extreme ultra-violet (EUV) mask.

2. Description of the Related Art

Since there is an increased need for more complicated light exposure processes, research is being actively conducted into a light exposure process using EUV light having a wavelength less than 50 nm. In order to check the influence of various defects of an EUV mask on a wafer in advance, an aerial image of the EUV mask needs to be reliably measured.

### SUMMARY

The inventive concept provides an apparatus for reliably measuring an aerial image of an EUV mask.

The inventive concept also provides a method of measuring an aerial image of an EUV mask by using the above apparatus.

According to an aspect of the inventive concept, there is provided an aerial image measuring apparatus including an extreme ultra-violet (EUV) light generation unit configured to generate EUV light, a moving unit configured to mount an EUV mask and to move the EUV mask in x and y axis directions, a primary reduction optics configured to primarily reduce a divergence of the EUV light generated by the EUV light generation unit, a secondary reduction optics configured to secondarily reduce the divergence of the primarily reduced EUV light, and a detection unit configured to sense energy information from the secondarily reduced EUV light reflected from the plurality of regions on the EUV mask, the secondarily reduced EUV light being incident on and reflected from a plurality of regions on the EUV mask.

The primary reduction optics may be one of a parabolic mirror and a spherical mirror.

The secondary reduction optics may include Schwarzschild optics.

The Schwarzschild optics may include a concave mirror and a convex mirror.

The concave mirror may include a first opening on an optical axis, the first opening being configured to receive the primarily reduced EUV therethrough, and a second opening configured to pass the EUV light reflected from the EUV mask toward the detection unit.

The apparatus may further include a pinhole mask between the primary reduction optics and the secondary reduction optics, the pinhole mask being configured to adjust the primarily reduced EUV light.

The apparatus may further include a beam splitter between the primary reduction optics and the secondary reduction optics, the beam splitter being configured to compensate for an intensity of the EUV light incident on the EUV mask.

The EUV light generation unit may include a light source configured to generate a high-power femtosecond laser light, a gas cell configured to generate a coherent EUV light having a certain wavelength by using the light source, and a lens configured to focus the femtosecond laser light on the gas cell.

The apparatus may further include a calculation unit configured to reconstruct the energy information sensed by the detection unit into image information of the EUV mask.

The apparatus may further include an X-ray mirror configured to select and reflect a wavelength of the EUV light generated by the EUV light generation unit toward the first reduction optics.

According to another aspect of the inventive concept, there is provided an aerial image measuring apparatus including a primary reduction optics configured to primarily reduce a divergence of an EUV light generated by an EUV light generation unit, a Schwarzschild optics configured to secondarily reduce the divergence of the primarily reduced EUV light, an EUV mask on a moving unit, the secondarily reduced EUV light being incident on and reflected from the EUV mask, and a detection unit configured to sense energy information from the secondarily reduced EUV light reflected from the EUV mask.

The primary reduction optics may be one of a parabolic mirror and a spherical mirror.

The Schwarzschild optics may include a concave mirror and a convex mirror.

The concave mirror may include a first opening on an optical axis, the convex mirror being positioned between the first opening and the EUV mask, and a second opening on a direct optical axis between the detection unit and the EUV mask.

The apparatus may further include a pinhole mask between the primary reduction optics and the Schwarzschild reduction optics, and a beam splitter between the pinhole mask and the Schwarzschild reduction optics.

According to yet another aspect of the inventive concept, there is provided an aerial image measuring method, including generating EUV light by using an EUV light generation unit, primarily reducing a divergence of the EUV light by using a primary reduction optics, secondarily reducing the divergence of the primarily reduced EUV light by using a secondary reduction optics, the secondarily reduced EUV light being incident on an EUV, moving a moving unit supporting the EUV mask, such that the secondarily reduced EUV light is incident on and reflected from a plurality of regions on the EUV mask, sensing energy information of the EUV light reflected from the plurality of regions on the EUV mask by using a detection unit, reconstructing the energy information sensed by the detection unit into image information by using a calculation unit, and storing the image information as matrix data, and outputting an aerial image of the EUV mask based on the matrix data by using the calculation unit.

Primarily reducing the divergence of the EUV light may include using one of a parabolic mirror and a spherical mirror.

Secondarily reducing the divergence of the primarily reduced EUV light may include using Schwarzschild optics having a concave mirror and a convex mirror.

The method may further include, after the EUV light is primarily reduced, adjusting the primarily reduced EUV light by using a pinhole mask.

The method may further include, after the primarily reduced EUV light is adjusted with the pinhole mask, compensating an intensity of the EUV light by using a beam splitter.

### BRIEF DESCRIPTION OF THE DRAWINGS

Features will become apparent to those of ordinary skill in the art by describing in detail exemplary embodiments with reference to the attached drawings, in which:

FIGS. 1 and 2 illustrate a schematic diagram and a block diagram, respectively, of an aerial image measuring apparatus according to an embodiment of the inventive concept;

FIG. 3A illustrates a diagram of operations of an EUV light generation unit and a reduction optics of the aerial image measuring apparatus illustrated in FIGS. 1 and 2;

FIG. 3B illustrates a diagram of Schwarzschild optics illustrated in FIG. 3A;

FIG. 4 illustrates a block diagram of a calculation unit of the aerial image measuring apparatus illustrated in FIGS. 1 and 2;

FIG. 5 illustrates a block diagram of operations of a detection unit and the calculation unit of the aerial image measuring apparatus illustrated in FIGS. 1 and 2;

FIG. 6 illustrates a flowchart of an aerial image measuring method according to an embodiment of the inventive concept; and

FIG. 7 illustrates a flowchart of an aerial image measuring method according to another embodiment of the inventive concept.

### DETAILED DESCRIPTION

Korean Patent Application No. 10-2011-0090205, filed on Sep. 6, 2011, in the Korean Intellectual Property Office, and entitled: “Method and Apparatus for Measuring Aerial Image of EUV Mask,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer (or element) is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

Also, spatially relative terms, such as “above,” “upper,” “beneath,” “below,” “lower,” and the like, may be used herein for ease of description to describe one element or feature's relationship to another element(s) or feature(s) as illustrated in the figures. Thus, the exemplary term “above” may encompass both an orientation of above and below.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but may be to include deviations in shapes that result, for example, from manufacturing. The inventive concept may be implemented as an individual embodiment or a combination of embodiments.

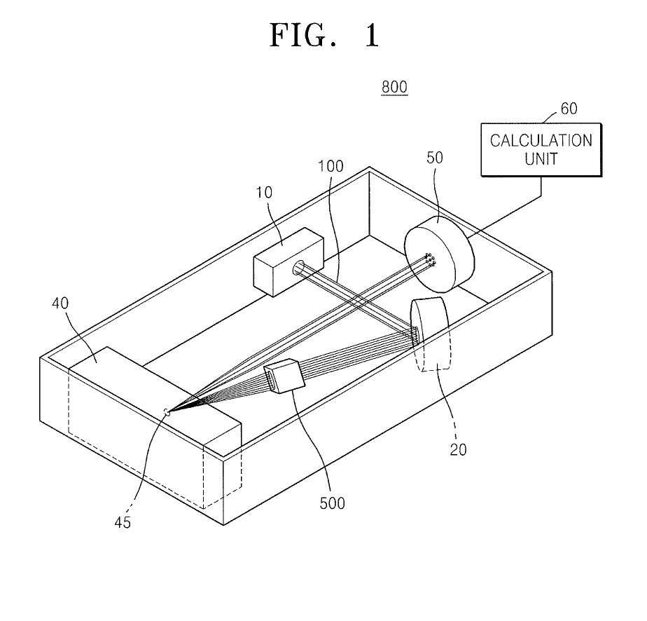

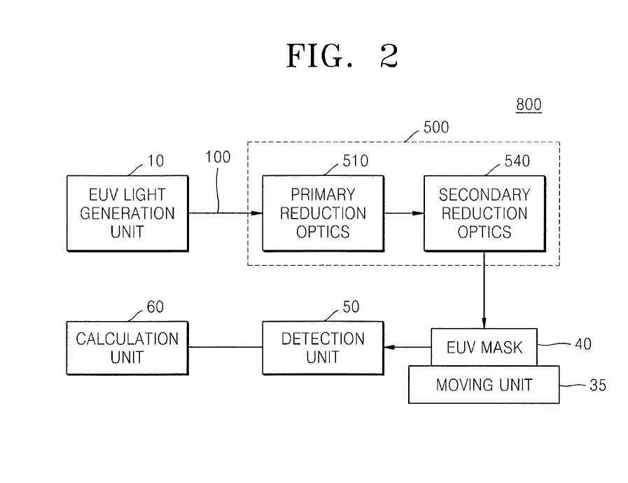

FIGS. 1 and 2 are a schematic diagram and a block diagram, respectively, of an aerial image measuring apparatus 800 according to an embodiment of the inventive concept. For example, the aerial image measuring apparatus 800 may be a scanning-type aerial image measuring apparatus, e.g., the aerial image measuring apparatus 800 may be a microscope.

Referring to FIGS. 1 and 2, the aerial image measuring apparatus 800 may include an EUV light generation unit 10, an X-ray mirror 20, reduction optics 500, a reflective EUV mask 40 (hereinafter referred to as an “EUV mask”), a moving unit 35 for mounting the EUV mask 40 and for moving the EUV mask 40 in x and y directions, a detection unit 50, and a calculation unit 60.

The EUV light generation unit 10 may generate coherent EUV light 100 having a wavelength of about 12 nm to about 14 nm. The EUV light 100 is incident on the X-ray mirror 20 to be reflected to ward the reduction optics 500.

The X-ray mirror 20 may select and reflect a wavelength of about 12 nm to about 14 nm from the EUV light 100. For example, the X-ray mirror 20 may select and reflect a wavelength of about 13.5 nm from the EUV light 100. The X-ray mirror 20 may not be included in some cases. The X-ray mirror 20 may be formed of palladium (Pd)/carbon (C), or molybdenum (Mo)/silicon (Si). For example, the X-ray mirror 20 may have a structure of a Mo/Si multilayer formed by alternately stacking about 80 Mo layers and Si layers. The Mo layers and the Si layers may be thin films formed by using a sputtering method.

The EUV light 100 reflected from the X-ray mirror 20 toward the reduction optics 500 reduces its divergence while passing through reduction optics 500, and is focused on a partial region 45 of the EUV mask 40. The reduction optics 500 reduces the divergence of the EUV light 100, and may include primary reduction optics 510 and secondary reduction optics 540. The reduction optics 500 may include optical elements that substantially minimize light dispersion, so the EUV light 100 is focused into a small pot on the partial region 45 of the EUV mask 40. In other words, the reduction optics 500 reduces light divergence of the EUV light 100 incident on the EUV mask 100, so a diameter of the light incident on the partial region 45 of the EUV mask 40 is substantially reduced. As will be described below, the reduction optics 500 has an excellent light focusing efficiency due to the primary reduction optics 510 and the secondary reduction optics 540, so scanning accuracy may be substantially increased.

The EUV light 100 focused on the partial region 45 is reflected from the EUV mask 40 toward the detection unit 50. The EUV mask 40 includes a reflective material. For example, the EUV mask 40 may have a micro circuit pattern having a width less than 45 nm on its upper surface. The detection unit 50 senses energy information of the EUV light 100 and transmits the energy information to the calculation unit 60.

The moving unit 35 for moving the EUV mask 40 in the x and y directions may be disposed under the EUV mask 40. The moving unit 35 may include a scanning stage for mounting the EUV mask 40. Accordingly, if the moving unit 35 moves the EUV mask 40 in the x and y axis directions, the EUV light 100 may be sequentially reflected from all regions of the EUV mask 40 while scanning the EUV mask 40. For example, if the EUV light 100 is stationary, i.e., an intersection of the EUV light 100 with a plane of the EUV mask 40 remains constant relative to the detection unit 50, movement of the moving unit 35 may move the EUV mask 40 relative to the stationary EUV light 100, thereby causing the EUV light 100 to be reflected from different points on the EUV mask 40, e.g., from all regions of the EUV mask 40. As such, the detection unit 50 may sense the energy information of the EUV light 100 from the whole upper surface region of the EUV mask 40 and may transmit the energy information to the calculation unit 60.

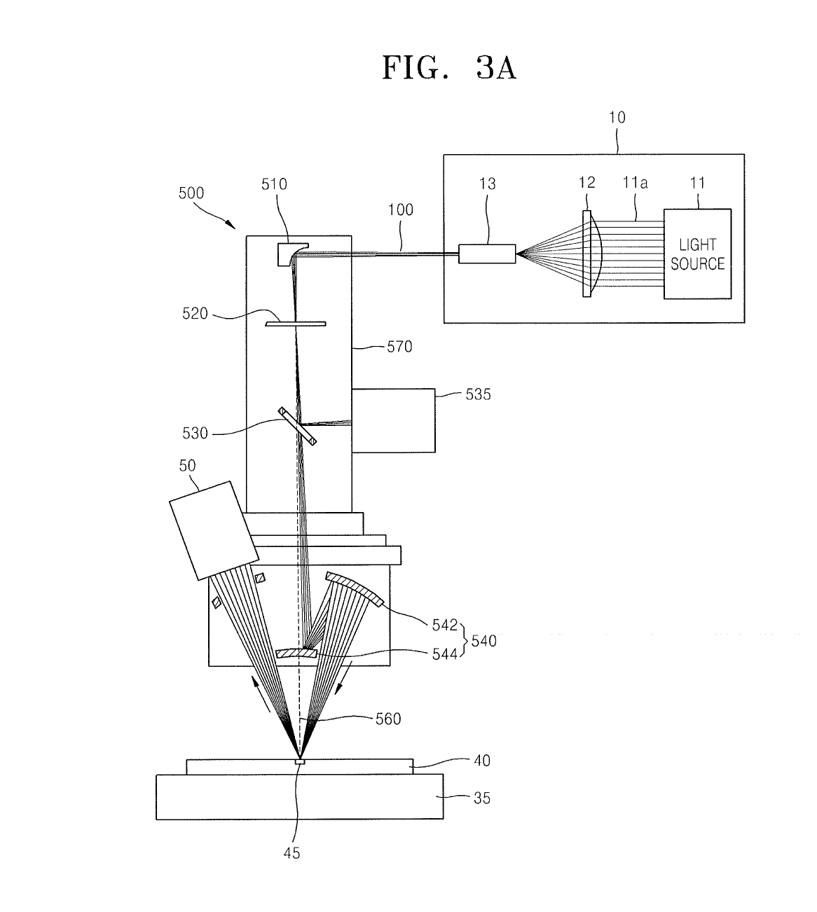

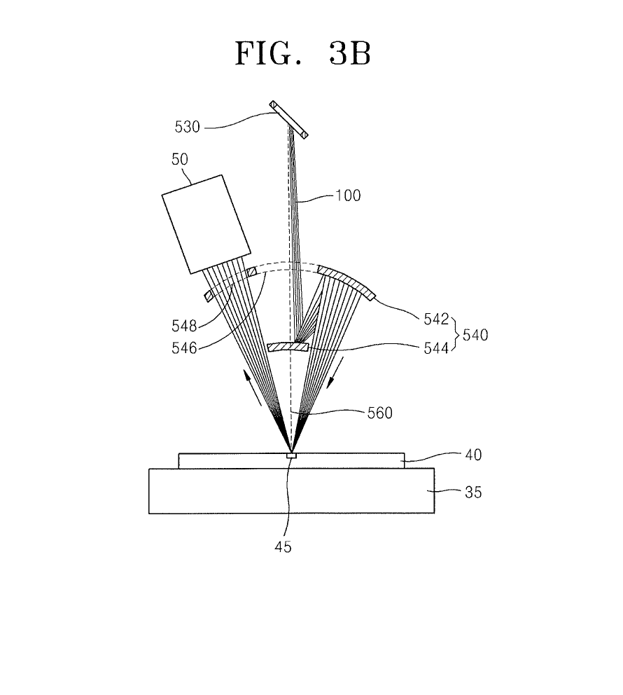

FIG. 3A is a diagram showing operations of the EUV light generation unit 10 and the reduction optics 500 of the aerial image measuring apparatus 800 illustrated in FIGS. 1 and 2. FIG. 3B is a diagram of Schwarzschild optics illustrated in FIG. 3A.

Specifically, the EUV light generation unit 10 may include a light source 11, e.g., a femtosecond laser, for generating ultrashort pulses of light, e.g., on a scale of femtoseconds, a lens 12, and a gas cell 13. The light source 11 may generate a high-power femtosecond laser light 11a, e.g., the femtosecond laser may be a titanium (Ti): sapphire laser. The femtosecond laser light 11a is focused on the gas cell 13 through the lens 12, so light emerging from the gas cell 13 is the EUV light 100. The gas cell 13 has a structure of a vacuum cell with micro holes in front and rear surfaces along a direction in which the femtosecond laser light 11a proceeds. The gas cell 13 may be filled with a neon gas so as to optimize the efficiency of generating the EUV light 100 having a wavelength of about 13.5 nm.

The EUV light 100 generated by the EUV light generation unit 10 passes through an X-ray mirror (not shown), is incident on the reduction optics 500, and is focused on the EUV mask 40. The reduction optics 500 may include the primary reduction optics 510 for primarily reducing the divergence of the EUV light 100. The primary reduction optics 510 may change the path of the EUV light 100. The primary reduction optics 510 may be, e.g., a parabolic mirror or a spherical mirror. As the primary reduction optics 510, the parabolic mirror may be an off-axis parabolic mirror.

The EUV light 100 incident on the primary reduction optics 510 and reflected therefrom passes through a pinhole mask 520. The pinhole mask 520 is disposed between the primary reduction optics 510 and the secondary reduction optics 540, and may adjust the size or shape of the EUV light 100 to be incident on the EUV mask 40. Also, the pinhole mask 520 may change the path of the EUV light 100 by adjusting the position of the EUV light 100 to be incident on the EUV mask 40. Due to the pinhole mask 520, an aerial image may be measured by reducing an influence according to the quality of the EUV light 100. The pinhole mask 520 may not be included in some cases.

The EUV light 100, having passed through the pinhole mask 520, passes through a beam splitter 530. The beam splitter 530 is disposed between the pinhole mask 520 and the secondary reduction optics 540 and may compensate for the intensity (energy) of the EUV light 100 to be incident on the EUV mask 40. The beam splitter 530 may pass a portion of the EUV light 100 toward the EUV mask 40, and may reflect the other portion of the EUV light 100 toward a light intensity detection unit 535. The light intensity detection unit 535 measures the intensity of the EUV light 100 reflected from the beam splitter 530. The beam splitter 530 may reduce variability in the intensity of the EUV light 100 by measuring the intensity of the EUV light 100 passed through the pinhole mask 520, thereby improving the quality of an aerial image. The beam splitter 530 may not be included in some cases.

The EUV light 100, having passed through the beam splitter 530, is incident on the secondary reduction optics 540. The secondary reduction optics 540 may focus the EUV light 100 on the EUV mask 40 by secondarily reducing the divergence of the EUV light 100 which is primarily reduced by the primary reduction optics 510. The secondary reduction optics 540 may be Schwarzschild optics.

As the secondary reduction optics 540, the Schwarzschild optics may include a concave mirror 542 and a convex mirror 544, as illustrated in FIGS. 3A and 3B. In more detail, the Schwarzschild optics may include the concave mirror 542 and the convex mirror 544 spaced apart from the concave mirror 542 on an optical axis 560, i.e., the concave mirror 542 and the convex mirror 544 may be spaced apart from each other along the optical axis 560. The concave mirror 542 and the convex mirror 544 are named with reference to an incident direction of the EUV light 100. The reflectance of the concave mirror 542 and the convex mirror 544 may be variously adjusted, for example, to 60%. The concave mirror 542 and the convex mirror 544 may have the same or different curvatures. The concave mirror 542 may include a first opening 546 formed on the optical axis 560 for receiving the primarily reduced EUV light 100, i.e., as reflected from the beam splitter 530, and a second opening 548, e.g., offset with respect to the optical axis 560, for passing the EUV light 100 reflected from the EUV mask 40. For example, the convex mirror 544 may be positioned to overlap the first opening 546 of the concave mirror 542, so light reflected from the beam splitter 530 passes through the first opening 546 to be incident on and reflected from the convex mirror 544 toward a first side (right side in FIG. 3B) of the concave mirror 542. The light is reflected from the first side of the concave mirror 542 to be incident on and reflected from the EUV mask 44, so the light passes through the second hole 548 to be incident on the detecting unit 50.

In detail, the EUV light 100, having passed through the first opening 546 of the concave mirror 542, is reflected from the convex mirror 544. The EUV light 100 incident on the convex mirror 544 may propagate toward one side of the optical axis 560. The EUV light 100 reflected from the convex mirror 544 is re-reflected from the concave mirror 542 and is focused and incident on the partial region 45 of the EUV mask 40.

As the Schwarzschild optics, the secondary reduction optics 540 may have a light focusing efficiency of about 36% when the EUV light 100 has a wavelength of about 13.5 nm. If the secondary reduction optics 540 includes a zone plate lens, the light focusing efficiency when the EUV light 100 has a wavelength of 13.5 nm is about 5%. Accordingly, the aerial image measuring apparatus 800 may improve the light focusing efficiency by using the primary reduction optics 510 and the secondary reduction optics 540.

The EUV light 100 incident on the partial region 45 of the EUV mask 40 is reflected toward the second opening 548 of the concave mirror 542, and the intensity of the EUV light 100 is detected by the detection unit 50. In FIG. 3A, a reference numeral 570 represents a housing for protecting and supporting the reduction optics 500, the pinhole mask 520, and the beam splitter 530.

As described above, the moving unit 35 disposed under the EUV mask 40 may allow the EUV light 100 to be sequentially reflected from all regions of the EUV mask 40, while scanning the EUV mask 40, by moving the EUV mask 40 in the x and y directions. The detection unit 50 may sense energy information of the EUV light 100 on the whole upper surface region of the EUV mask 40.

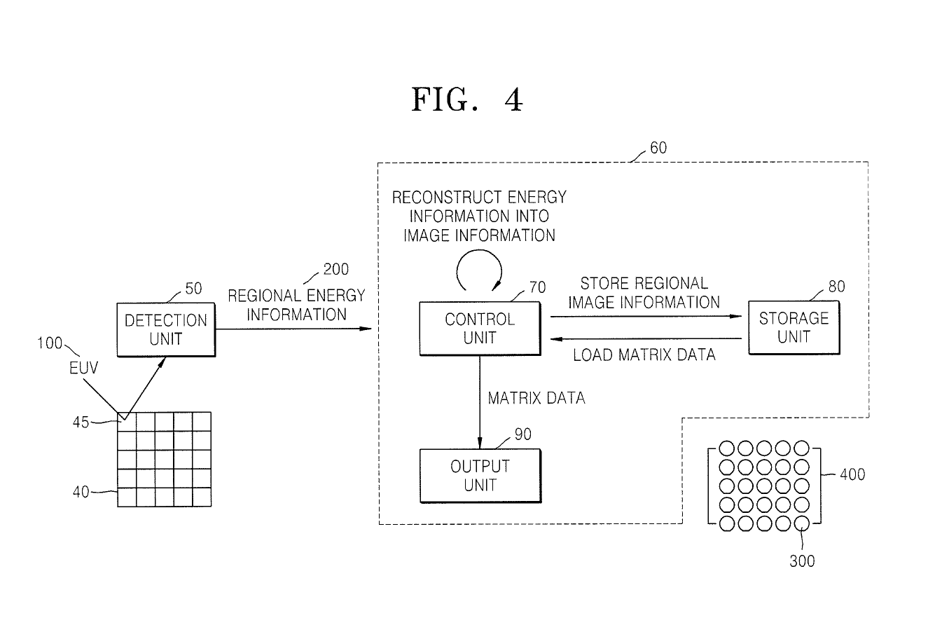

FIG. 4 is a block diagram of the calculation unit 60 of the aerial image measuring apparatus 800 illustrated in FIGS. 1 and 2. Referring to FIG. 4, the calculation unit 60 may include a control unit 70, a storage unit 80, and an output unit 90. If the EUV light 100 is reflected from the partial region 45 of the EUV mask 40 and is sensed by the detection unit 50, energy information 200 is transmitted to the control unit 70.

The control unit 70 reconstructs the transmitted energy information 200 into image information 300. The reconstructed image information 300 may be a number obtained by converting the luminance of the EUV light 100 into a value from 0 to 1. The reconstructed image information 300 is transmitted to the storage unit 80.

The storage unit 80 may store the reconstructed image information 300 of the EUV mask 40, as matrix data 400. For example, if the EUV mask 40 includes five rows and five columns, e.g., if the EUV mask 40 is divided into a plurality of regions to function as partial regions 45 arranged in five rows and five columns, the reconstructed image information 300 may be stored as the matrix data 400 in five rows and five columns. The control unit 70 loads the matrix data 400 stored in the storage unit 80 and transmits the loaded matrix data 400 to the output unit 90. The output unit 90 outputs an aerial image of the EUV mask 40 based on the transmitted matrix data 400.

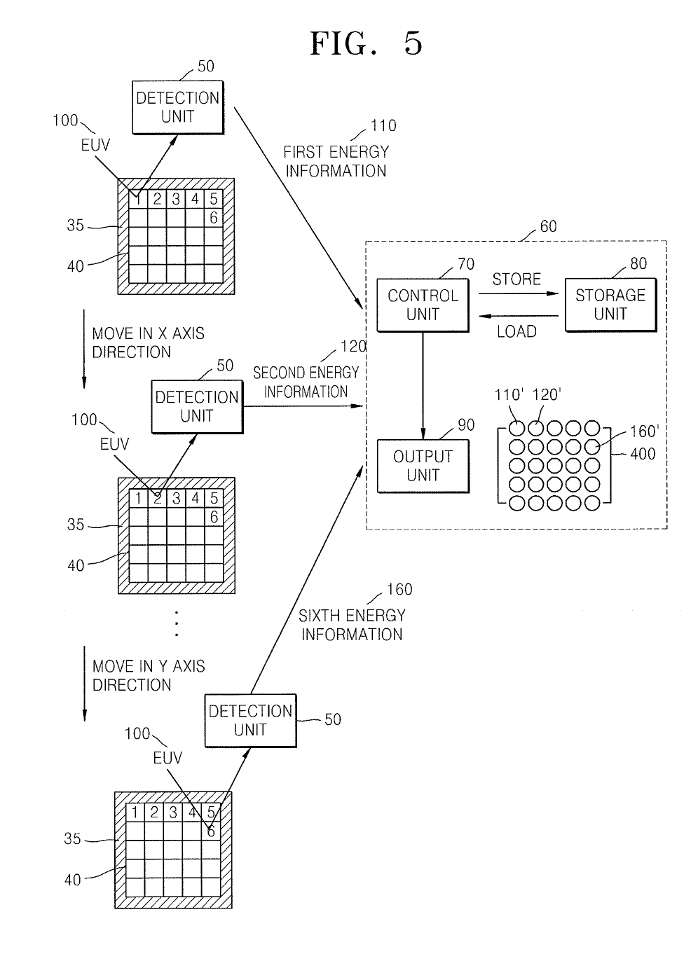

FIG. 5 is a block diagram showing operations of the detection unit 50 and the calculation unit 60 of the aerial image measuring apparatus 800 illustrated in FIGS. 1 and 2.

In detail, the EUV light 100 is reflected from a first region (indicated by “1” on mask 40 in FIG. 5) of the EUV mask 40 including 25 regions, and the detection unit 50 senses the EUV light 100 and transmits first energy information 110 to the calculation unit 60. The control unit 70 of the calculation unit 60 reconstructs the transmitted first energy information 110 into first image information 110′. The reconstructed first image information 110′ is transmitted to the storage unit 80, and the storage unit 80 stores the first image information 110′ in a first row of a first column of the matrix data 400 having five rows and five columns. After that, the moving unit 35 moves the EUV mask 40 along the x axis direction.

Next, the EUV light 100 is reflected from a second region of the EUV mask 40 (indicated by “2” on the mask 40), and the detection unit 50 senses the EUV light 100 and transmits second energy information 120 to the calculation unit 60. The control unit 70 of the calculation unit 60 reconstructs the transmitted second energy information 120 into second image information 120′. The reconstructed second image information 120′ is transmitted to the storage unit 80, and the storage unit 80 stores the second image information 120′ in the first row of a second column of the matrix data 400. After that, the moving unit 35 continued moving the EUV mask 40 along the same direction, i.e., along a same x axis direction.

In this manner, if energy information of first through fifth regions of the EUV mask 40 is reconstructed into image information, and the reconstructed image information is stored in the storage unit 80 as the matrix data 400, the moving unit 35 moves the EUV mask 40 along the y axis direction, i.e., once a first row of regions on the EUV mask 40 is scanned and processed the moving unit 35 positions the EUV mask 40 to scan and process a second row of regions thereon. Accordingly, the EUV light 100 is reflected on a sixth region of the EUV mask 40, and sixth energy information 160 sensed by the detection unit 50 is transmitted to the calculation unit 60. The control unit 70 reconstructs the transmitted sixth energy information 160 into sixth image information 160′, and the reconstructed sixth image information 160′ is transmitted to the storage unit 80 and is stored in a second row of a fifth column of the matrix data 400.

Energy information of first through twenty-fifth regions of the EUV mask 40 is reconstructed into image information by moving the EUV mask 40 in the x and y axis directions, and the reconstructed image information is stored in the storage unit 80 as the matrix data 400. If the reconstructed image information of all regions of the EUV mask 40 is stored in the storage unit 80, the control unit 70 loads the matrix data 400 stored in the storage unit 80. The output unit 90 outputs an aerial image of the EUV mask 40 based on the matrix data 400 transmitted from the control unit 70.

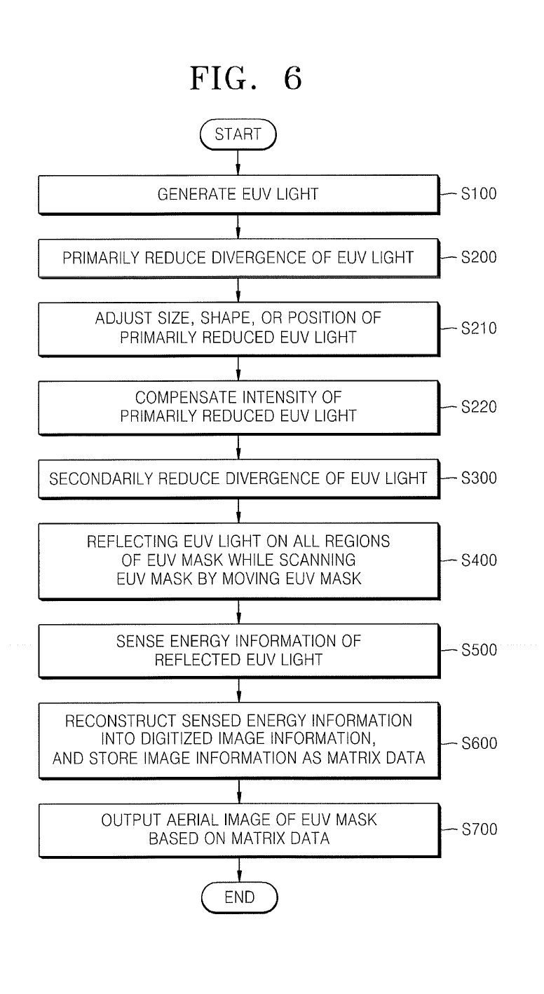

FIG. 6 is a flowchart of an aerial image measuring method according to an embodiment of the inventive concept.

Referring to FIG. 6, the EUV light 100 is generated (operation S100), and the generated EUV light 100 may be emitted toward and reflected from the X-ray mirror 20 if necessary. The divergence of the EUV light 100 generated by the EUV light generation unit 10 is primarily reduced (operation S200). The divergence of the EUV light 100 may be primarily reduced by using the primary reduction optics 510 formed as a parabolic mirror or a spherical mirror.

The size, shape, or position of the primarily reduced EUV light 100 is adjusted if necessary (operation S210). The primarily reduced EUV light 100 may be adjusted by using the pinhole mask 520. After the primarily reduced EUV light 100 is adjusted, the intensity of the primarily reduced EUV light 100 is compensated if necessary (operation S220). The intensity of the primarily reduced EUV light 100 may be compensated by using the beam splitter 530.

The divergence of the primarily reduced EUV light 100 is secondarily reduced (operation S300). The divergence of the primarily reduced EUV light 100 may be secondarily reduced by using the secondary reduction optics 540 formed as Schwarzschild optics including a pair of a concave mirror and a convex mirror.

The secondarily reduced EUV light 100 is reflected from each region of the EUV mask 40, while scanning the EUV mask 40 by moving the EUV mask 40 in x and y axis directions (operation S400). The detection unit 50 senses energy information of the EUV light 100 reflected on the EUV mask 40 (operation S500). The sensed energy information is reconstructed into digitized image information, and the image information is stored in the storage unit 80 as the matrix data 400 (operation S600). If the image information of all regions of the EUV mask 40 is stored as the matrix data 400, an aerial image of the EUV mask 40 is output based on the matrix data 400 (operation S700).

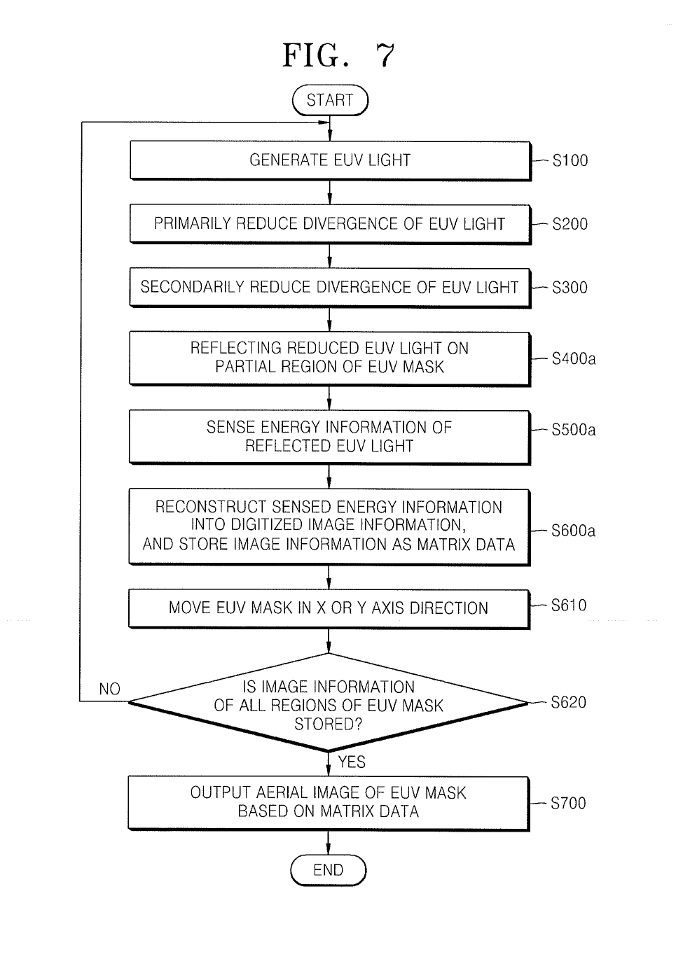

FIG. 7 is a flowchart of an aerial image measuring method according to another embodiment of the inventive concept. The method of FIG. 7 is similar to the method of FIG. 6, so descriptions of same operations will not be repeated.

Referring to FIG. 7, after operations S100 through 5300, the secondarily reduced EUV light 100 is reflected from the partial region 45 of the EUV mask 40 (operation S400a). Energy information of the EUV light 100 reflected from the partial region 45 of the EUV mask 40 is sensed (operation S500a). The sensed energy information is reconstructed into digitized image information, and the image information is stored in the storage unit 80 as the matrix data 400 (operation S600a).

The EUV mask 40 is moved in an x or y axis direction (operation S610). It is checked whether the image information of all regions of the EUV mask 40 is stored (operation S620). If the image information of all regions of the EUV mask 40 is not stored, operations S100, S200, S300, S400a, S500a, S600a, S610, and S620 are repeated. If the image information of all regions of the EUV mask 40 is stored, an aerial image of the EUV mask 40 is output based on the matrix data 400 (operation S700).

According to example embodiments, an aerial image measuring apparatus may include a plurality of reduction optics to minimize divergence of light incident on the EUV mask. In particular, a Schwarzschild optics may be used as a secondary reduction optics, so a light focusing efficiency may be greatly improved. Further, the aerial image measuring apparatus may include a pinhole mask and a beam splitter between the reduction optics to reduce an influence of the quality of EUV light reflected from the EUV mask, thereby improving the quality of the aerial image. In contrast, use of a zoneplate in a conventional aerial image measuring apparatus as reduction optics (or focusing optics) may provide a very low efficiency of focusing EUV light, thereby reducing the quality of the aerial image.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. An aerial image measuring apparatus, comprising:
an extreme ultra-violet (EUV) light generation unit configured to generate EUV light;
a moving unit configured to mount an EUV mask and to move the EUV mask in x and y axis directions;
a primary reduction optics configured to primarily reduce a divergence of the EUV light generated by the EUV light generation unit;
a secondary reduction optics configured to secondarily reduce the divergence of the primarily reduced EUV light; and
a detection unit configured to sense energy information from the secondarily reduced EUV light reflected from the plurality of regions on the EUV mask, the secondarily reduced EUV light being incident on and reflected from a plurality of regions on the EUV mask.

2. The apparatus as claimed in claim 1, wherein the primary reduction optics is one of a parabolic mirror and a spherical mirror.

3. The apparatus as claimed in claim 1, wherein the secondary reduction optics includes Schwarzschild optics.

4. The apparatus as claimed in claim 3, wherein the Schwarzschild optics includes a concave mirror and a convex mirror.

5. The apparatus as claimed in claim 4, wherein the concave mirror includes:
a first opening on an optical axis, the first opening being configured to receive the primarily reduced EUV therethrough; and
a second opening configured to pass the EUV light reflected from the EUV mask toward the detection unit.

6. The apparatus as claimed in claim 1, further comprising a pinhole mask between the primary reduction optics and the secondary reduction optics, the pinhole mask being configured to adjust the primarily reduced EUV light.

7. The apparatus as claimed in claim 6, further comprising a beam splitter between the primary reduction optics and the secondary reduction optics, the beam splitter being configured to compensate for an intensity of the EUV light incident on the EUV mask.

8. The apparatus as claimed in claim 1, wherein the EUV light generation unit includes:
a light source configured to generate a high-power femtosecond laser light;
a gas cell configured to generate a coherent EUV light having a certain wavelength by using the light source; and
a lens configured to focus the femtosecond laser light on the gas cell.

9. The apparatus as claimed in claim 1, further comprising a calculation unit configured to reconstruct the energy information sensed by the detection unit into image information of the EUV mask.

10. The apparatus as claimed in claim 1, further comprising an X-ray mirror configured to select and reflect a wavelength of the EUV light generated by the EUV light generation unit toward the first reduction optics.

11. An aerial image measuring apparatus, comprising:
a primary reduction optics configured to primarily reduce a divergence of an extreme ultra-violet (EUV) light generated by an EUV light generation unit;
a Schwarzschild optics configured to secondarily reduce the divergence of the primarily reduced EUV light;
an EUV mask on a moving unit, the secondarily reduced EUV light being incident on and reflected from the EUV mask; and
a detection unit configured to sense energy information from the secondarily reduced EUV light reflected from the EUV mask.

12. The apparatus as claimed in claim 11, wherein the primary reduction optics is one of a parabolic mirror and a spherical mirror.

13. The apparatus as claimed in claim 12, wherein the Schwarzschild optics includes a concave mirror and a convex mirror.

14. The apparatus as claimed in claim 13, wherein the concave mirror includes:
a first opening on an optical axis, the convex mirror being positioned between the first opening and the EUV mask; and
a second opening on a direct optical axis between the detection unit and the EUV mask.

15. The apparatus as claimed in claim 13, further comprising:
a pinhole mask between the primary reduction optics and the Schwarzschild reduction optics; and
a beam splitter between the pinhole mask and the Schwarzschild reduction optics.

16.-20. (canceled)
